(19) United States
(12) Patent Application Publication
(10) Pub. No.: US 2024/0228776 A1
(43) Pub. Date: Jul. 11, 2024

(54) HEAT STABILIZED COMPOSITION

(71) Applicant: BYK-Chemie GmbH, Wesel (DE)

(72) Inventor: Robert Arechederra, Earth City, MO (US)

(21) Appl. No.: 18/558,256

(22) PCT Filed: May 5, 2022
(86) PCT No.: PCT/EP2022/062146

§ 371 Date: Oct. 31, 2023

(30) Foreign Application Priority Data
May 7, 2021 (EP) 21172848.0

(51) Int. Cl. C08L 77/00; C08K 3/105

(52) U.S. Cl. CPC C08L 77/00; C08K 3/105; C08K 2201/014; C08L 2201/08

(57) ABSTRACT

The present invention relates a composition comprising a polyamide and a modified polysaccharide, a three-dimensional object comprising the same and a use and method for stabilizing a polyamide against heat.

### TECHNICAL FIELD

The present invention relates a composition comprising a polyamide and a modified polysaccharide, a three-dimensional object comprising the same and a use and method for stabilizing a polyamide against heat.

### BACKGROUND

Polyamides and polyamide compositions have the tendency to rapidly deteriorate and degrade at elevated temperatures beyond 150° ° C. to 180° C. Plastic molded parts attached to an engine in the automotive industry in turn are exposed to temperatures beyond the temperature range of 150° ° C. to 180° C. and are therefore prone to rapid deterioration and degradation of compositions or parts comprising polyamides in these ranges in particular when exposed thereto over longer time.

The prior art addresses the thermal stability issues of polyamides inter alia by substituting them with very expensive specialty polymers and/or using them with specific additives. Thereby, the industry is faced with only limited types of suitable polymer materials beyond the temperature range of 150° C. to 180° C. and/or limited polyamide compositions with stability beyond the temperature range of 150° C. to 180° C.

There is a need of the industry to use existing polyamides and/or polyamide compositions and increase their thermal stability beyond the temperature of 150° C. to 180° C. in particular when exposed thereto over longer time.

The present invention overcomes the issues of the prior art and meets the needs of the industry for extending the temperature range of polyamide compositions, in particular aliphatic polyamide compositions and in particular when exposed thereto over longer time by using at least one of an alkylated polysaccharide, a hydroxy-alkylated polysaccharide, and an acetylated polysaccharide as a heat stabilizer.

### DESCRIPTION OF THE FIGURES

FIG. 1—Tensile strength measurement results of formulation samples A to D upon heating for 1000 h at 210° C.

FIG. 2—Tensile strength measurement results of formulation samples E to H upon heating for 1000 h at 210° C.

FIG. 3—Tensile strength measurement results of formulation C upon heating for 1000 h at 230° ° C.

### DETAILED DESCRIPTION OF THE INVENTION

The present invention relates to a composition comprising
at least one of an alkylated polysaccharide, a hydroxy-alkylated polysaccharide, and an acetylated polysaccharide and
a polyamide,
   wherein the polysaccharide is comprised in the composition in an amount from 0.10 to 8.0% by weight, based on the total weight of the composition.

The present invention is able to extend the temperature range beyond 150° C. to 180° C. of polyamide compositions, in particular aliphatic polyamide compositions, and in particular upon exposure over longer time ranges.

The composition according to the present invention comprises at least one of an alkylated polysaccharide, a hydroxy-alkylated polysaccharide, and an acetylated polysaccharide.

The expression alkylated polysaccharide or hydroxy-alkylated polysaccharide is herein understood as a compound in which a hydroxyalkyl or alkyl group, preferably hydroxyalkyl group is linked to a polysaccharide moiety. The hydroxyalkyl or alkyl group, preferably hydroxyalkyl group may be linked to the polysaccharide moiety naturally or artificially, such as by means of chemical or enzymatic synthesis.

The polysaccharide moiety may comprise any polysaccharide comprising at least 5, preferably 10 monosaccharide monomers linked to each other by glycosidic bonds, such as for example linked to each other by alpha and/or beta glycosidic bonds. The polysaccharide moiety of may comprise a cellulose, alkyl cellulose, such as a C₁₋₄ alkylcellulose, preferably a methylcellulose, ethylcellulose or ethyl methyl cellulose, arabinoxylan, chitin or pectin moiety.

The hydroxyalkyl group of the hydroxyalkylated polysaccharide may be a linear or branched C₁₋₁₀ hydroxyalkyl, preferably a linear or branched C₂₋₅ hydroxyalkyl group. The hydroxy group of the hydroxyalkyl group of the hydroxyalkylated polysaccharide may be a primary or secondary hydroxy group. The hydroxyalkyl group may linked to the polysaccharide moiety by an ester bond, an ether bond, an amide bond or an amino bond, preferably an ether bond. The hydroxyalkylated polysaccharide has suitably has a degree of hydroxyalkylation of at least 80 mol-%, based on the percentage of hydroxyalkylation of potential free linking groups of the respective polysaccharide. Hydroxyalklyation generally occurs via reaction of free hydroxyl groups of the polysaccharide with an alkylene oxide, preferably ethylene oxide or propylene oxide. When the polysaccharides are hydroxyalkylated with propylene oxide, the hydroxylated polysaccharide generally comprises 20 to 80 weight-%, preferably 22 to 65 weight-%, of reacted propylene oxide, calculated on the weight of the hydroxylated polysaccharide.

The alkyl group of the alkylated polysaccharide may be a linear or branched C₁₋₁₀ alkyl, preferably a linear or branched C₂₋₅ alkyl group. The alkyl group may be linked to the polysaccharide moiety by an ester bond, an ether bond, an amide bond or an amino bond, preferably an ether bond. The alkylated polysaccharide generally has a degree of alkylation of 30 to 100%, based on the percentage of alkylation of potential free linking groups of the respective polysaccharide.

The alkylated polysaccharide preferably comprises a cellulose or methyl cellulose moiety. The terms cellulose and methyl cellulose are well known to a person skilled in the art. The alkylated polysaccharide may be an alkylated cellulose or methyl cellulose.

The alkylated or hydroxy-alkylated polysaccharide preferably comprises at least 1, preferably 2 free alcohol groups per 5 monosaccharide monomer units. The alkylated or hydroxy-alkylated polysaccharide preferably comprises at least 2, preferably at least 3, more preferably at least 4 free alcohol groups per 10 monosaccharide monomer units.

In some embodiments, the alkylated or hydroxy-alkylated polysaccharide comprises not more than 1 free alcohol groups per 5 monosaccharide monomer units. In further embodiments, the (hydroxy)alkylated polysaccharide preferably comprises not more than 1 free alcohol group per 10 monosaccharide monomer units.

The number of free alcohol groups mentioned above relates to the number of hydroxyl groups on the monomer units, which have not been alkylated or hydroxy-alkylated. The hydroxyl groups generated by hydroxy-alkylation with alkylene oxides are not taken into account.

The alkylated or hydroxy alkylated polysaccharide preferably is selected from the group consisting of hydroxypropyl cellulose, hydroxyethyl cellulose, hydroxypropyl methylcellulose, ethyl hydroxyethyl cellulose, methyl cellulose, ethyl cellulose, ethyl methyl cellulose, and any mixtures thereof, preferably hydroxypropylcellulose. The acetylated polysaccharide may be cellulose acetate.

The alkylated or hydroxy-alkylated or acetylated polysaccharide may be comprised in the composition in an amount of at least 0.010% by weight, preferably at least 0.050% by weight, more preferably from 0.10% by weight, based on the total weight of the composition. The alkylated or hydroxy-alkylated or alkylated polysaccharide may be comprised in the composition in an amount of not more than 25% by weight, preferably 15% by weight, more preferably not more than 8.0% by weight, based on the total weight of the composition. The alkylated or hydroxy-alkylated or alkylated polysaccharide may be comprised in the composition in an amount from 0.010% to 25% by weight, based on the total weight of the composition. The alkylated or hydroxy-alkylated or alkylated polysaccharide is preferably comprised in the composition in an amount from 0.050% to 15% by weight, more preferably from 0.10 to 8.0% by weight, based on the total weight of the composition.

The composition according to the present invention comprises a polyamide.

The term polyamide is well known to a person skilled in the art. The term polyamide relates to a polymer with repeating units linked with amide bonds.

The polyamide may be an aliphatic, aromatic or aliphatic-aromatic polyamide. The expression aliphatic, aromatic or aliphatic-aromatic polyamide are well known to a person skilled in the art.

Typical aliphatic polyamides may comprise polyamide 6 (PA6) derived for example from polymerizing 6-aminocapronic acid or caprolactam, polyamide 12 (PA12) which can be derived for example from polymerizing laurinlactam, polyamide 66 (PA66) which can be derived for example from hexamethylenediamine and adipic acid, polyamide 610 (PA610) which can ber derived from 1,6-hexandiamin and sebacinic acid, polyamide 612 (PA612) which can be derived for example from 1,6-hexane diamin and dodecandic acid. Typical aromatic polyamides or aramides may comprise of an aromatic monomer component such as phthalic acid derived compounds and/or phenylene diamine derived compounds. Typical aliphatic-aromatic polyamides may comprise of a mixture of both aromatic and aliphatic monomers that would be polymerized together or a physical blend of discreate aromatic polyamide, aliphatic polyamides, or aromatic-aliphatic polyamides.

The polyamide may be preferably an aliphatic polyamide.

The polyamide may be comprised in the composition in an amount of at least 75% by weight, preferably at least 85% by weight, more preferably at least 90% by weight of the polyamide, based on the total weight of the composition. The polyamide may be comprised in the composition in an amount of not more than 99.09% by weight, preferably not more than 99.950% per weight, more preferably from 99.9% by weight, based on the total weight of the composition. The polyamide may be comprised in the composition in an amount from 75 to 99.09% by weight, preferably 85 to 99.95% by weight, more preferably from 90 to 99.9% by weight, based on the total weight of the composition.

The composition according to the present invention may further comprise an additional heat stabilizer.

The additional heat stabilizer may preferably be different from the alkylated or hydroxy-alkylated polysaccharide according to the present invention.

The further heat stabilizer may be selected from an organic heat stabilizer, such as phenolic antioxidant, phosphite, phosphine derivatives, hindered amine, melamine, thio-ether, thiol, thio-ester, thiocarbamate, a polyhydric alcohol containing more than two hydroxyl groups or an aromatic amine, or an inorganic heat stabilizer, such as a copper salt or an iodine salt, or any mixture thereof. The phenolic antioxidant may be selected from hindered phenolic compounds, semi-hindered phenolic compounds, or unhindered phenolic compounds. The polyhydric alcohols containing more than two hydroxyl groups may be selected from the group consisting of polyhydric alcohol containing more than two hydroxyl groups include triols, such as glycerol, trimethylolpropane, 2,3-di-(2′-hydroxyethyl)-cyclohexan-1-ol, hexane-1,2,6-triol, 1,1,1-tris-(hydroxymethyl)ethane, 3-(2′-hydroxyethoxy)-propane-1,2-diol, 3-(2′-hydroxypropoxy)-propane-1,2-diol, 2-(2′-hydroxyethoxy)-hexane-1,2-diol, 6-(2′-hydroxypropoxy)-hexane-1,2-diol, 1,1,1-tris-[(2′-hydroxyethoxy)-methyl]-ethane, 1,1,1-tris-[(2′-hydroxypropoxy)-methyl]-propane, 1,1,1-tris-(4′-hydroxyphenyl)-ethane, 1,1,1-tris-(hydroxyphenyl)-propane, 1,1,3-tris-(dihydroxy-3-methyl-phenyl)-propane, 1,1,4-tris-(dihydroxyphenyl)-butane, 1,1,5-tris-(hydroxyphenyl)-3-methyl-pentane, di-trimethylopropane, trimethylolpropane ethoxylates, or trimethylolpropane propoxylates; polyols such as pentaerythritol, dipentaerythritol, and tripentaerythritol; and saccharides, such as cyclodextrin, D-mannose, glucose, galactose, sucrose, fructose, xylose, arabinose, D-mannitol, D-sorbitol, D- or L-arabitol, xylitol, iditol, talitol, allitol, altritol, guilitol, erythritol, threitol, and D-gulonic-y-lactone; and the like. The aromatic amine may be selected from any aniline derived compound, phenylene diamine derived compound, pyridinic compound, or pyrolic compound. The amine of the aromatic amine can be either a pendant group on the aromatic structure, or incorporated into the aromatic structure. The copper salt may be selected from copper copper containing compound, but copper iodide is preferred. The halide salt may be selected from any of the alkali metals or alkaline earth metals and the halide can be chloride, bromide, or iodide. In certain copper stabilization systems the halide salt can be replaced with an aliphatic halide.

The further heat stabilizer may be comprised in the composition in an amount from 0.010% to 8.000% by weight, based on the total weight of the composition. The further heat stabilizer may be preferably comprised in the composition from 0.050 to 4.000% by weight, more preferably from 0.100 to 2.000% by weight, based on the total weight of the composition.

The composition according to the present invention may further comprise a toughener, plasticizer, flame retardant, reinforcement agent or any mixture thereof.

A toughener is an additive that increases the mechanical robustness, or thoughness, of a composition. By “thoughening” of a composition a person skilled in the art understands the ability of the polymeric substance to absorb energy and plastically deform without increasing fracture. Typical toughener suitable for the composition may be selected from the group consisting of a copolymer of ethylene, glycidyl (meth)acrylate, and optionally one or more (meth)acrylate esters; an ethylene/α-olefin or ethylene/α-olefin/diene copolymer grafted with an unsaturated carboxylic anhydride; a copolymer of ethylene, 2-isocyanatoethyl (meth)acrylate, and optionally one or more (meth)acrylate esters; and a copolymer of ethylene and (meth)acrylic acid reacted with a Zn, Li, Mg or Mn compound to form the corresponding ionomer.

The toughener may be comprised in the composition in an amount of from 0.00 to 50.00% by weight, preferably 0.01 to 25.00% by weight, based on the total weight of the composition.

A plastizicer is an additive that is added to a material to make it softer and more flexible, to increase its plasticity, to decrease its viscosity, or to decrease friction during its handling in manufacture The plastizer may be preferably be miscible with the polyamide. Typical plasticizers suitable for the composition may include sulfonamides, preferably aromatic sulfonamides such as benzenesulfonamides and toluenesulfonamides. Examples of suitable sulfonamides include N-alkyl benzenesulfonamides and toluenesulfonamides, such as N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide, and the like. Preferred are N-butylbenzenesulfonamide, N-ethyl-o-toluenesulfonamide, and N-ethyl-p-toluenesulfonamide.

The plasticizer may be comprised in the composition in an amount from 1 to 20% by weight, preferably from 6 to 18% by weight, more preferably from 8 to 15% by weight, based on the total weight of the composition.

A reinforcement agent is a substance to improve the physical properties such as resilience and tensile strength. Typical reinforcement agents suitable for the composition may comprise calcium carbonate, glass fibers with circular and noncircular cross-section, glass flakes, glass beads, carbon fibers, talc, mica, wollastonite, calcined clay, kaolin, diatomite, magnesium sulfate, magnesium silicate, barium sulfate, titanium dioxide, sodium aluminum carbonate, barium ferrite, potassium titanate and mixtures thereof. Glass fibers, glass flakes, talc, and mica are preferred reinforcement agents.

The reinforcement agent may be comprised in the composition in an amount from 0 to 60% by weight, preferably 10 to 60% by weight, more preferably from 15 to 50% by weight, based on the total weight of the composition.

The present invention also relates to a process of making a three-dimensional object comprising a composition according to the present invention, wherein the three-dimensional object is formed by extrusion or by molding.

The process of extruding or molding a polyamide composition and means to carry out these processes are well known to a person skilled in the art. Extrusion is a process used to create objects of a fixed cross-sectional profile, wherein a material is pushed through a die of the desired cross-section. Molding is a process of manufacturing by shaping liquid or pliable raw material using a rigid frame called a mold or matrix.

The present invention also relates to a three-dimensional object comprising the composition according to the invention.

The three-dimensional can be preferably obtained by the process described herein-above.

Three dimensional objects, in particular extruded or molded three dimensional objects, can be selected from the group consisting of charge air coolers (CAC), cylinder head covers (CHC), oil pans, engine cooling systems, such as thermostat and heater housings and coolant pumps, exhaust systems, such as mufflers and housings for catalytic converters, air intake manifolds (AIM) and timing chain belt front covers. Other molded or extruded three dimensional objects can be selected from the group consisting of pipes for transporting liquids and gases, inner linings for pipes, fuel lines, air break tubes, coolant pipes, air ducts, pneumatic tubes, hydraulic houses, cable covers, cable ties, connectors, canisters, and push-pull cables.

The three-dimensional object may have a tensile strength of the polyamide composition of the three-dimensional object is higher than 30 MPa, preferably higher than 40 MPa, more preferably higher than 60 MPa after 500 h at 210° C.

The three-dimensional object may preferably have a tensile strength of the polyamide composition of the three-dimensional object is higher than 20 MPa, preferably higher than 30 MPa, more preferably higher than 50 MPa after 1000 h at 210° C.

The three-dimensional object may have a decrease in tensile strength of the polyamide composition of the three-dimensional objection of less than 50% after 1000 h at 210° C.

The present invention also relates to an engine or an engine component comprising the three-dimensional object according to the present invention.

The engine or the engine component is preferably an automotive engine or engine component.

The engine or the engine component is preferably part of an electrical or electronic system.

The present invention also relates to a motor vehicle comprising the three-dimensional object according to the present invention.

The motor vehicle is preferably a car, truck, boat, train, airplane, scooter or motorcycle.

The present invention also relates to the use of a (hydroxy)alkylated polysaccharide for thermal stabilization of a polyamide.

The (hydroxy)alkylated polysaccharide and polyamide are according to the embodiments and definitions as described herein-above.

All further embodiments as described herein-above apply mutatis mutandis.

Thermal stabilization may be that the polyamide composition has a tensile strength of more than 30 MPa, preferably higher than 40 MPa, more preferably higher than 60 MPa after 500 h at 210° C.

Thermal stabilization may be that the polyamide composition has a tensile strength of more than 20 MPa, preferably higher than 30 MPa, more preferably higher than 50 MPa after 1000 h at 210° C.

Thermal stabilization may be that the decrease in tensile strength of the polyamide composition of the three-dimensional objection of less than 50% at after 1000 h at 210° C.

The present invention also relates to a method for stabilizing a polyamide against heat comprising the steps of
a) providing a polyamide,
b) adding at least one of an alkylated polysaccharide, a hydroxy-alkylated polysaccharide, and an acetylated polysaccharide,
c) mixing the polyamide with the at least one of an alkylated polysaccharide, a hydroxy-alkylated polysaccharide, and an acetylated polysaccharide,
d) optionally, including an additional heat stabilizer in one of steps a) to c).

The polyamide, the at least one of an alkylated polysaccharide, a hydroxy-alkylated polysaccharide, and an acetylated polysaccharide, and additional heat stabilizer are according to the embodiments and definitions as described herein-above.

All further embodiments as described herein-above apply mutatis mutandis.

The present invention also relates to the method for increasing the thermal stability of a polyamide composition comprising the steps of
a) Providing a polyamide,
b) Providing at least one of an alkylated polysaccharide, a hydroxy-alkylated polysaccharide, and an acetylated polysaccharide,
c) mixing the polyamide with the at least one of an alkylated polysaccharide, a hydroxy-alkylated polysaccharide, and an acetylated polysaccharide,
d) optionally, including an additional heat stabilizer in one of steps a) to c).

The polyamide, the at least one of an alkylated polysaccharide, a hydroxy-alkylated polysaccharide, and an acetylated polysaccharide, and additional heat stabilizer are according to the embodiments and definitions as described herein-above.

All further embodiments as described herein-above apply mutatis mutandis.

### Examples

### 1) Materials

Polyamide 6,6, Melamine, Cuprous Iodide, Potassium Iodide, N,N-Diphenyl-p-phenylenediamine “Flexamine”, Zinc Stearate, and Hydroxypropylcellulose (Klucel H ex Ashland) are commercially available and used for these examples.

### 2) Methods

All polyamide resins was dried in a vacuum oven for 12 hrs at 40° C. under a hard vacuum of 760 mmhg. All other components were pulverized with a mortar and pestle to fine powders prior to mixing into each formulation. Fully formulated samples were compounded using a small lab scale twin screw extruder with a flat temperature profile of 285° C. Compounded samples were stranded, chopped, and then dried in a vacuum oven for 12 hrs at 40° C. under a hard vacuum of 760 mmhg prior to injection molding in a 50T lab scale single screw injection molder at 285° C. Injection molded dog bone samples were then placed into an oven a thermally aged for set periods of time at a set temperature. After thermal aging samples were conditioned at 50% relative humidity for 24 hrs before tensile testing.

### 3) Formulations:

Sample A: 0.1% CuI, 0.1% zinc stearate, 0.8% potassium iodide, 99.0% polyamide 66.
Sample B: 0.1% CuI, 0.1% zinc stearate, 0.8% potassium iodide, 1.0% hydroxypropylcellulose, 1.0% melamine, 97.0% polyamide 66.
Sample C: 0.1% CuI, 0.1% zinc stearate, 0.8% potassium iodide, 2.0% hydroxypropylcellulose, 0.5% melamine, 96.5% polyamide 66.
Sample D: 0.1% CuI, 0.1% zinc stearate, 0.8% potassium iodide, 2.0% hydroxypropylcellulose, 2.0% melamine, 95.0% polyamide 66.
Sample E: 8.0% N,N-Diphenyl-p-phenylenediamine, 92.0% polyamide 66.
Sample F: 5.0% N,N-Diphenyl-p-phenylenediamine, 2.0% melamine, 93.0% polyamide 66.
Sample G: 2.0% N,N-Diphenyl-p-phenylenediamine, 2.0% hydroxypropylcellulose, 2.0% melamine, 94.0% polyamide 66.
Sample H: 2.0% N,N-Diphenyl-p-phenylenediamine, 5.0% hydroxypropylcellulose, 2.0% melamine, 91.0% polyamide 66.

### 4) Results

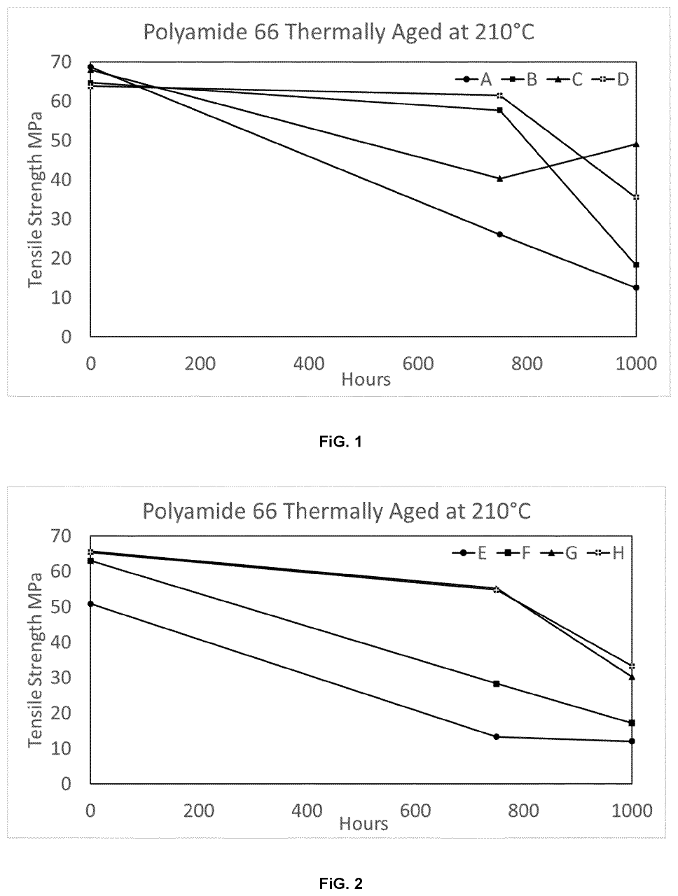

FIG. 1 shows that compositions B to D according to the present invention comprising a hydroxyalkylated polysaccharide show a significantly increased thermal stability after 1000 h at 210° C. over composition A not according to the present invention.

FIG. 2 shows that compositions G and H according to the present invention comprising a hydroxyalkylated polysaccharide show an increased thermal stability over compositions E and F not according to the present invention.

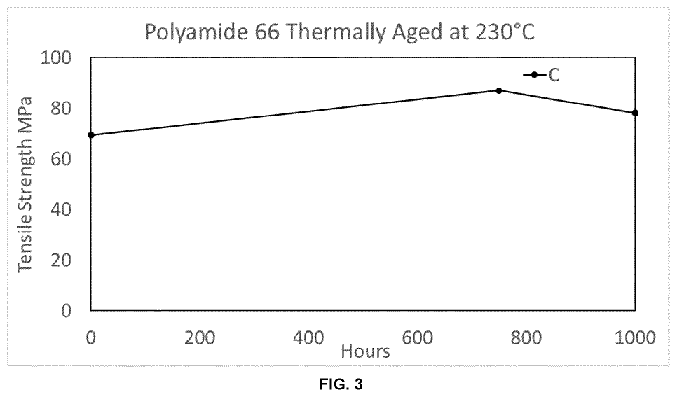

FIG. 3 shows that composition C according to the present invention comprising a hydroxyalkylated polysaccharide show a very high thermal stability after 1000 h even at 230° C.

1. A composition comprising
a polysaccharide including at least one of an alkylated polysaccharide, a hydroxy-alkylated polysaccharide, and an acetylated polysaccharide, and
a polyamide,
wherein the composition comprises the polysaccharide in an amount from 0.10 to 8.0% by weight, based on the total weight of the composition.

2. The composition according to claim 1, wherein the polysaccharide comprises a cellulose or methyl cellulose moiety.

3. The composition according to claim 1, wherein the polyamide is an aliphatic polyamide, an aromatic polyamide, or an aliphatic-aromatic polyamide.

4. The composition according to claim 1, wherein the composition comprises at least 75% by weight of the polyamide, based on the total weight of the composition.

5. The composition according to claim 1, further comprising an additional heat stabilizer.

6. The composition according to claim 5, wherein the additional heat stabilizer includes one or more of an organic heat stabilizer or an inorganic heat stabilizer.

7. The composition according to claim 5, wherein the composition comprises the additional heat stabilizer in an amount from 0.010% to 8.000% by weight, based on the total weight of the composition.

8. A process of making a three-dimensional object, the process comprising forming the three-dimensional object by extruding or molding the composition according to claim 1.

9-12. (canceled)

13. A method for stabilizing a polyamide against heat, the method comprising:
a) providing a polyamide,
b) adding a polysaccharide to the polyamide, the polysaccharide including at least one of an alkylated polysaccharide, a hydroxy-alkylated polysaccharide, and an acetylated polysaccharide, and
c) mixing the polyamide with the polysaccharide.

14. A method for increasing the thermal stability of a polyamide composition, the method comprising:
a) providing a polyamide,
b) adding a polysaccharide the polyamide, the polysaccharide including at least one of an alkylated polysaccharide, a hydroxy-alkylated polysaccharide, and an acetylated polysaccharide, and
c) mixing the polyamide with the polysaccharide.

15. The composition according to claim 1, wherein the polysaccharide includes one or more of hydroxypropyl cellulose, hydroxyethyl cellulose, hydroxypropyl methylcellulose, ethyl hydroxyethyl cellulose, methyl cellulose, ethyl cellulose, ethyl methyl cellulose, and cellulose acetate.

16. The composition according to claim 5, wherein the additional heat stabilizer is different from the hydroxy-alkylated polysaccharide.

17. The composition according to claim 5, wherein the additional heat stabilizer includes one or more of a phenolic antioxidant, a polyhydric alcohol containing more than two hydroxyl groups, an aromatic amine, a copper salt, or an iodine salt.

18. The composition according to claim 5, wherein the composition comprises the additional heat stabilizer in an amount from 0.050 to 4.000% by weight, based on the total weight of the composition.

19. The composition according to claim 5, wherein the composition comprises the additional heat stabilizer in an amount from 0.100 to 2.000% by weight, based on the total weight of the composition.

20. A three-dimensional object obtained by the process according to claim 8.

21. The three-dimensional object according to claim 20, the object comprising an engine or engine component.

22. A motor vehicle comprising the three-dimensional object according to claim 20.

23. The method of claim 13, comprising adding an additional heat stabilizer in one of a) to c).

24. The method of claim 14, comprising including a further heat stabilizer in one of a) to c).
